(19) United States
(12) Patent Application Publication
(10) Pub. No.: US 2009/0019983 A1
(43) Pub. Date: Jan. 22, 2009

(54) PINNACLE DIE STRUCTURE HAVING SCRAP COLLECTING OPENING

(75) Inventor: Sun-Hoo Park, Seoul (KR)

Correspondence Address: CANTOR COLBURN, LLP, 20 Church Street, 22nd Floor, Hartford, CT, 06103, US

(73) Assignee: KDS INTECH CO., LTD., Seoul (KR)

(21) Appl. No.: 11/572,552

(22) PCT Filed: Jul. 1, 2006
(86) PCT No.: PCT/KR2006/002580

§ 371 Date: Jan. 23, 2007

(30) Foreign Application Priority Data
Nov. 30, 2005 (KR) 1020050115181

(51) Int. Cl. B26F 1/44

(52) U.S. Cl. 83/684; 83/168; 83/697

(57) ABSTRACT

Disclosed herein is a pinnacle die structure having a scrap collecting opening. The pinnacle die structure comprises a pinnacle die(100), which includes a supporting plate(10) integrally formed with a cutter blade(20) and at least one hole-processing pin(30). The hole-processing pin is internally formed with a scrap discharge hole(32) to discharge a scrap(202) of a material sheet(200) punched by the pinnacle die. A scrap collecting opening(40) is defined above the hole-processing pin to collect the scrap discharged from the scrap discharge hole.

### TECHNICAL FIELD

The present invention relates a pinnacle die structure having a scrap collecting opening, and more particularly, to a pinnacle die structure comprising a pinnacle die including a supporting plate integrally formed with a cutter blade and at least one hole-processing pin, wherein the hole-processing pin is internally formed with a scrap discharge hole to discharge scraps of a material sheet, and scrap collecting opening is positioned right above the hole-processing pin to collect the scraps discharged from the scrap discharge hole.

### BACKGROUND ART

In general, a die-board is called a wooden die or Thomson knife die, and includes a supporting plate, and a plurality of punches and cutter blades coupled to the supporting plate. The supporting plate is made of steel, wood, resin, or the like, and is subjected to a laser or SCSI cutting process to have a predetermined pattern space therein. The cutter blades are fabricated via several processes using bending and cutting machines, and are interference fitted, along with the punches, in the predetermined pattern space of the supporting plate in various arrangements.

Recently, the application range of die-boards is expanding from processing of simple products, such as paper boxes or printed articles, to processing of precision products. It is known that die-boards can achieve an improvement in the productivity and quality of products as compared to prior art molds, in particular, in fields of half-cutting and special-cloth cutting which are impossible with the prior art molds. Furthermore, since die-boards have no need for a base die unlike prior art molds, they have advantages of shortened production time and inexpensive manufacturing costs, and enable low-cost fabrication of samples. For these reasons, it can be said that die-boards are suitable for mass-production of multiple items as well as small-quantity production.

Conventionally, such a die-board is used to cut a variety of objects such as an LCD film, sealing element, electronic tag, gasket, printed article, vacuum molded article, rubber or sponge material, and the like, and is fabricated by preparing a supporting plate made of one selected from among a variety of materials, and interference fitting a plurality of cutter blades to the supporting plate based on a desired pattern. In use of the die-board fabricated as stated above, first, the die-board is disposed on an object to be cut. Then, as the die-board is compressed by use of a press located thereabove, the object is able to be cut, by the cutter blades, into a product having a desired shape. The conventional die-board, however, has a problem in that it is difficult to separate the product from the cutter blades because the product is tightly caught between the cutter blades. To solve this problem, elastic members such as elastic pads, etc. have been bonded onto the supporting plate around the respective cutter blades. The elastic members are compressed when the cutter blades of the die-board press and cut the object, but are expanded when the die-board is lifted after completing a cutting operation. Thereby, as the elastic members push the resulting cut product upward, the product can be easily separated from the cutter blades.

As one example of conventional die-boards, now, a conventional pinnacle die will be explained hereinafter.

The conventional pinnacle die includes a supporting plate integrally formed with a cutter blade and hole-processing pin. In use of the conventional pinnacle die, it is first disposed on an object to be cut, for example, a plastic sheet, and subsequently, is compressed by use of a press located thereabove. Using the conventional pinnacle die, however, has a problem in that scraps separated from the plastic sheet may be jammed in the hole-processing pin of the pinnacle die. Accordingly, to pull the scraps of the plastic sheet out of the hole-processing pin, the conventional pinnacle die has a need for an additional troublesome process for digging out every scrap jammed in the hole-processing pin after compressing the pinnacle die with the press. Furthermore, when the conventional pinnacle die is disposed on the plastic sheet and subsequently, is compressed by use of the press to punch a hole through the plastic sheet, there is a problem in that the punched hole portion of the plastic sheet may be incompletely separated from the plastic sheet. Therefore, after compressing the pinnacle die using the press, the punched hole portion of the plastic sheet must be disposed on a jig for the implementation of an additional drilling process. Such a drilling process, however, has problems of unintentional tearing of or damage to the plastic sheet at the hole portion and increased labor and production costs.

### DISCLOSURE

### Technical Problem

Therefore, the present invention has been made in view of the above problems, and it is an object of the present invention to provide a pinnacle die structure comprising a pinnacle die including a supporting plate integrally formed with a cutter blade and at least one hole-processing pin, wherein the hole-processing pin is internally formed with a scrap discharge hole to discharge scraps of a material sheet, for example, plastic sheet, out of the pinnacle die, and a scrap collecting opening is positioned right above the hole-processing pin to collect the scraps discharged from the scrap discharge hole, thereby preventing scraps separated from the material sheet from being jammed in the hole-processing pin when the pinnacle die, disposed on the plastic sheet, is compressed by use of a press located thereabove, and therefore, eliminating a need for a conventional troublesome process for digging out every scrap of the plastic sheet jammed in the hole-processing pin after compressing the pinnacle die using the press.

It is another object of the present invention to provide a pinnacle die structure which can ensure a punched hole portion of a material sheet, for example, plastic sheet, to be completely separated from the plastic sheet when a pinnacle die, disposed on the plastic sheet, is compressed by use of a press located thereabove, thereby eliminating a need for an additional drilling process for drilling the hole portion of the plastic sheet on a jig, after compressing the pinnacle die using the press.

It is yet another object of the present invention to provide a pinnacle die structure which can eliminate a conventional drilling process for repeatedly drilling a punched hole portion of a material sheet, thereby preventing unintentional tearing of or damage to the material sheet at the hole portion while preventing an increase in labor and production costs.

### Technical Solution

In accordance with an aspect of the present invention, the above and other objects can be accomplished by the provision of a pinnacle die structure having a scrap collecting opening, the pinnacle die structure comprising a pinnacle die which includes a supporting plate integrally formed with a cutter blade and at least one hole-processing pin, wherein the hole-processing pin is internally formed with a scrap discharge hole to discharge a scrap of a material sheet.

### Advantageous Effects

In a pinnacle die structure according to the present invention comprising a pinnacle die including a supporting plate integrally formed with a cutter blade and at least one hole-processing pin, the hole-processing pin is internally formed with a scrap discharge hole to discharge scraps of a material sheet punched by the pinnacle die, and a scrap collecting opening is located above the hole-processing pin to collect the scraps discharged from the scrap discharge hole. Such a pinnacle die structure having the above described configuration achieves an integral automatic scrap discharge jig. Thereby, when the pinnacle die, which is disposed on a material sheet, for example, plastic sheet, is compressed by a press located thereabove, the press operation can be completed via a single process without requiring a separate process. This has the effect of preventing generation of poor products during the press operation and reducing labor and production costs.

### DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a pinnacle die according to the present invention;

FIG. 2 is a perspective view illustrating a pinnacle die structure having a scrap collecting opening according to the present invention;

FIG. 3 is a bottom exploded perspective view of the pinnacle die structure having the scrap collecting opening according to the present invention;

FIG. 4 is a top exploded perspective view of the pinnacle die structure having the scrap collecting opening according to the present invention, which illustrates a scrap of a material sheet being discharged from the pinnacle die;

FIG. 5 is a sectional view of the pinnacle die structure having the scrap collecting opening according to the present invention;

FIG. 6 is a sectional view of the pinnacle die structure having the scrap collecting opening according to the present invention, which illustrates a scrap of the material sheet being discharged from the pinnacle die; and

FIG. 7 is an exploded perspective view illustrating a pinnacle die structure having a plurality of scrap collecting openings according to an alternative embodiment of the present invention.

### BEST MODE

Now, preferred embodiments of the present invention will be explained in detail with reference to the accompanying drawings.

The present invention relates to a pinnacle die structure comprising a pinnacle die 100 in which a supporting plate 10 is integrally formed with a cutter blade 20 and at least one hole-processing pin 30. The hole-processing pin 30 is internally defined with a scrap discharge hole 32, to discharge a scrap 202 of a material sheet 200. The pinnacle die structure of the present invention further comprises a scrap collecting opening 40, which is located above the hole-processing pin 30 to collect the scrap 202 discharged from the scrap discharge hole 32.

Considering other configurations of the pinnacle die structure according to the present invention, a synthetic resin film 50 is provided to cover an open top side of the scrap collecting opening 40, in order to allow the scrap 202 of the material sheet 200, which is discharged from the scrap discharge hole 32 of the hole-processing pin 30, to be collected in the scrap collecting opening 40. Also, the scrap collecting opening 40 is formed, along an inner periphery thereof, with a pair of pin supports 42 and 42′ to support the edge of a pin blade (not shown) of the hole-processing pin 30. In the pinnacle die structure of the present invention, furthermore, two or more scrap collecting openings may be integrally formed with each other. The pinnacle die structure having the scrap collecting opening 40 according to the present invention comprises: the pinnacle die 100 forming a bottom layer of the pinnacle die structure and including the supporting plate 10 integrally formed with the cutter blade 20 and hole-processing pin 30; an iron board 60 disposed on an upper surface of the pinnacle die 100; a wooden scrap collecting board 70 disposed on an upper surface of the iron board 60; the synthetic resin film 50 attached to an upper surface of the wooden scrap collecting board 70; and a plurality of fixing pins 80 and 80′ penetrated, in the following sequence, through the synthetic resin film 50, wooden scrap collecting board 70, iron board 60, and pinnacle die 100 so as to fixedly secure them together.

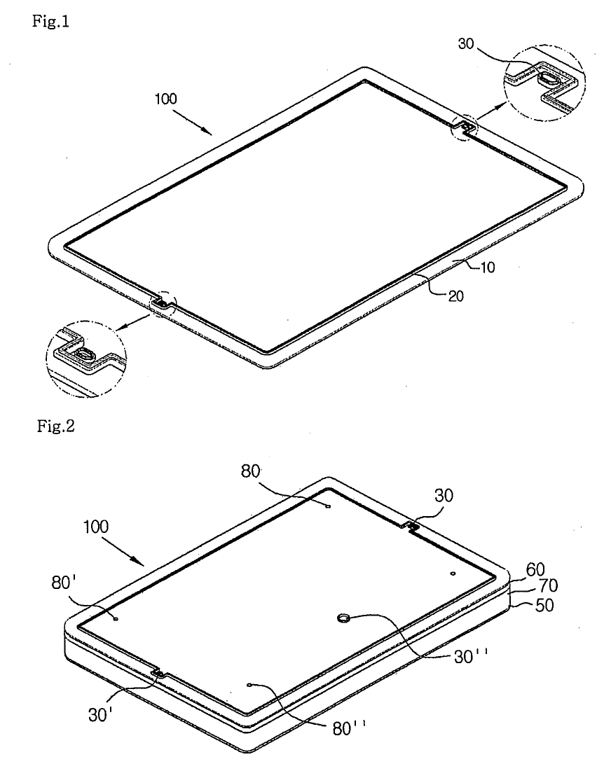

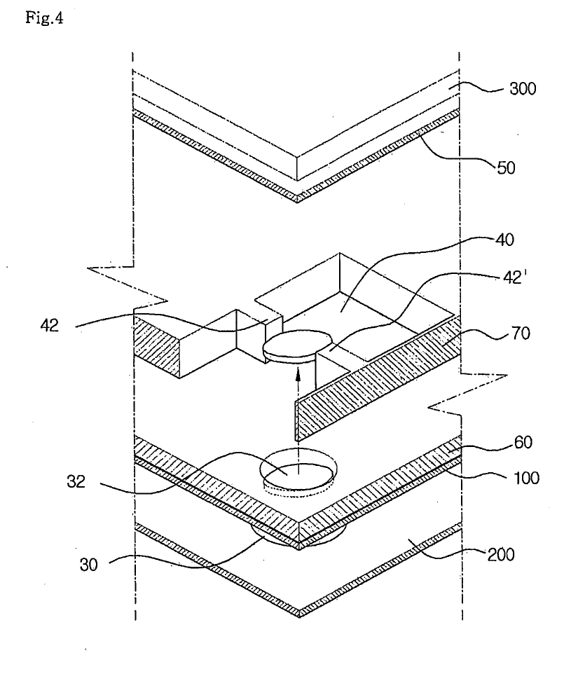

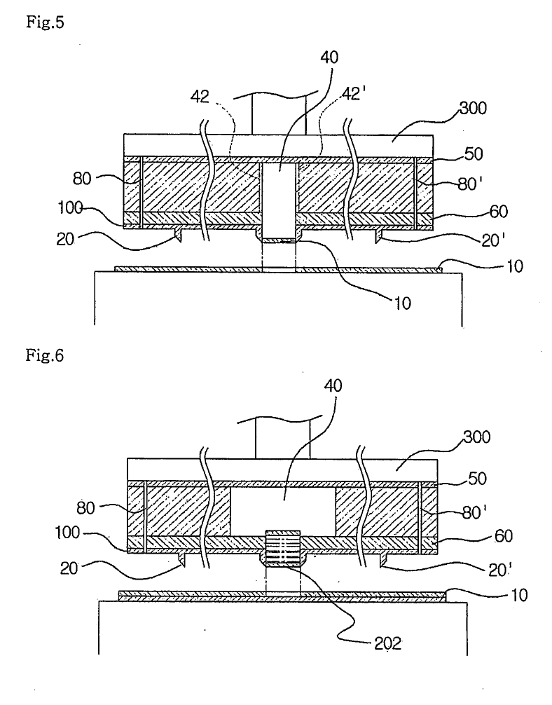

Referring to FIG. 1, the pinnacle die 100 of the present invention is fabricated by corroding an iron plate to obtain the supporting plate 10 having a predetermined pattern, and integrally mounting the cutter blade 20 and hole-processing pin 30 along the predetermined pattern on the supporting plate 10. Referring to FIGS. 2 to 7, preferably, if the pinnacle die 100 including the supporting plate 10 integrally formed with the cutter blade 20 and hole-processing pin 30 is prepared, the iron board 60 is stacked on the pinnacle die 100, and then, the wooden scrap) collecting board 70, on which the synthetic resin film 50 was attached, is stacked on the iron board 60, to complete the pinnacle die structure,

Considering a punching process using the pinnacle die structure according to the present invention, after the pinnacle die 100 is disposed on the material sheet to be punched, for example, plastic sheet 200, the pinnacle die 100 is compressed by a press 300 thereabove. In this punching process, since the scrap discharge hole 32 is perforated through the hole-processing pin 30, every punched hole portion of the plastic sheet 200, namely, scrap 202 of the plastic sheet 200, is completely separated from the plastic sheet 200, and piled up in the scrap discharge hole 32. Thereby, as the upper scarp 202 is pushed upward by the lower scrap 202, the scraps 202 are able to be discharged from the scrap discharge hole 32 one by one. Thereafter, the scraps 202 discharged from the scrap discharge hole 32 are moved into the scrap collecting opening 40 since the scrap collecting opening 40 is located above the hole-processing pin 30. In this case, due to the synthetic resin film 50 covering the open top side of the scrap collecting opening 40, the scraps 202 of the plastic sheet 200 discharged from the scrap discharge hole 32 are able to be stably collected in the scrap collecting opening 40. The synthetic resin film 50 covering the open top side of the scrap collecting opening 40 may be formed of one selected from among a variety of synthetic resin films, but is preferably formed of a polyethylene terephthalate film. In the pinnacle die structure of the present invention, the reason why the iron board 60 is mounted on the pinnacle die 100 is to achieve uniform distribution of a compressive force being applied by the press 300 onto the pinnacle die 100 while preventing damage to the pinnacle die 100. The iron board 60 is preferably formed of a SUS-iron board.

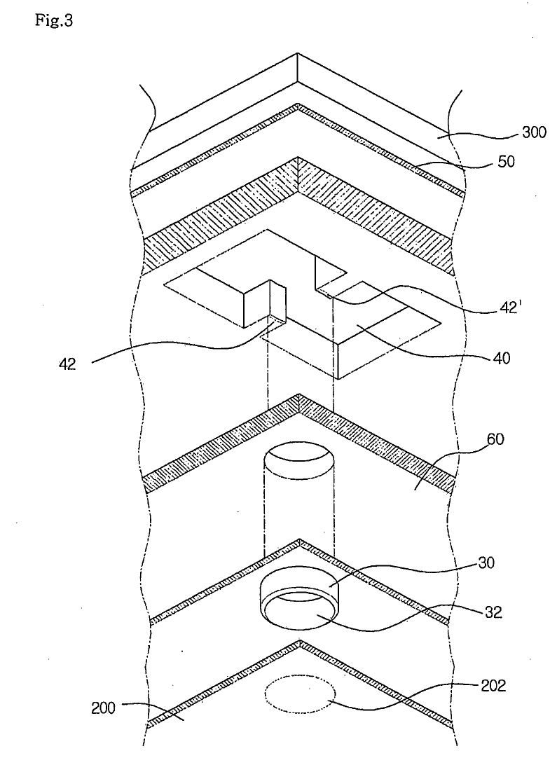

As shown in FIGS. 3 to 7, in the pinnacle die structure of the present invention, the scrap collecting opening 40 is formed with the pin supports 42 and 42′ at positions coming in contact with the edge of the pin blade (not shown) of the hole-processing pin 30, to support the edge of the pin blade. Thereby, the scrap collecting opening 40 can achieve a space sufficient for allowing the scraps 202 separated from the material sheet 200 to be smoothly discharged from the scrap discharge hole 32 into the scrap collecting opening 40. When the pin blade of the hole-processing pin 30 is hit by the press 300, also, the pin supports 42 and 42′ serve as protrusions for supporting the pin blade of the hole-processing pin 30, thereby preventing droop of or damage to the pin blade of the hole-processing pin 30.

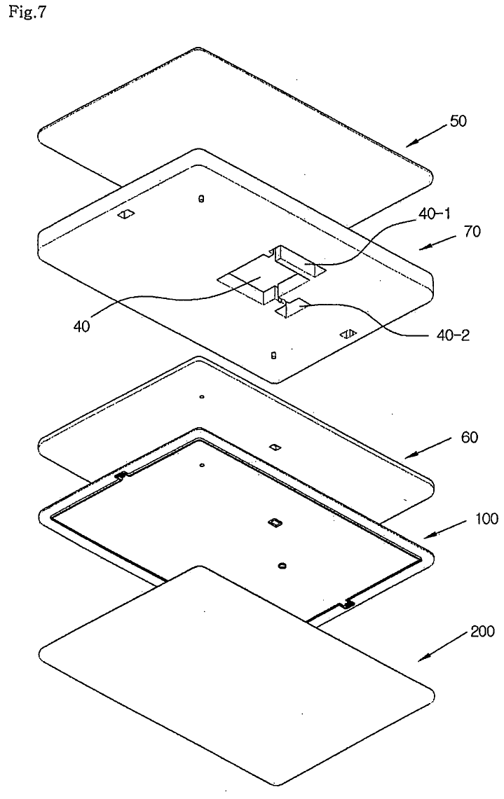

Although one scrap collecting opening 40 is included in the pinnacle die structure of the present invention as shown in FIGS. 1 to 6, it should be understood that a plurality of scrap collecting openings may be provided. For example, in an alternative embodiment of the present invention as shown in FIG. 7, three scrap collecting openings 40, 40-1 and 40-2 may be provided to be integrally formed with one another.

In summary, as shown in FIGS. 2 to 7, the pinnacle die structure having the scrap collecting opening according to the present invention takes the form of an integral automatic scrap discharge jig comprising: the pinnacle die 100 including the supporting plate 10 integrally formed with the cutter blade 20 and hole-processing pin 30; the SUS iron board 60 stacked on the pinnacle die 100; the wooden scrap collecting board 70 stacked on the iron board 60; the polyethylene terephthalate film 50 attached to the upper surface of the wooden scrap collecting board 70; and the plurality of fixing pins 80 and 80′ penetrated through the above stacked elements 50, 70, 60, and 100 to fixedly secure them together. When the pinnacle die 100, disposed on the plastic sheet 200, is compressed by the press 300 to punch a hole through the plastic sheet 200, such a punching process can be completed via a single press operation without requiring an addition process for removing the scrap 202 of the plastic sheet 200 from the hole-processing pin 30 of the pinnacle die 100. With the punching process using the pinnacle die 100 of the present invention, furthermore, there is no risk that the scrap 202 of the plastic sheet 200 is incompletely punched and fails to be separated from the plastic sheet even after compressing the pinnacle die 100 disposed on the plastic sheet 200 with the press 300. Therefore, like the prior alt, the present invention can eliminate a need for an additional drilling process for drilling the incompletely punched hole portion of the plastic sheet while disposing the hole portion of the plastic sheet on a jig. Elimination of the drilling process can prevent tearing of or damage to the punching object at the hole portion while preventing an increase in labor costs and production costs.

In an alternative embodiment of the present invention, instead of integrally forming the supporting plate of the pinnacle die with the cutter blade and hole-processing pin, the hole-processing pin may be separately prepared and welded to a desired position of the pinnacle die.

In another alternative embodiment of the present invention, the hole-processing pin may take the form of a block to be fitted into a through-hole perforated in the supporting plate of the pinnacle die at a predetermined position.

The present invention has an advantage of using a pinnacle die integrally formed with the hole-processing pin having the scrap discharge hole perforated therethrough.

### Industrial Applicability

As apparent from the above description, the present invention provides a pinnacle die structure comprising a pinnacle die including a supporting plate integrally formed with a cutter blade and at least one hole-processing pin, wherein the hole-processing pin is internally formed with a scrap discharge hole to discharge scraps of a material sheet punched by the pinnacle die, and a scrap collecting opening is located above the hole-processing pin to collect the scraps discharged from the scrap discharge hole. When a press operation is performed by use of such an integral automatic scrap discharge jig, namely, when the pinnacle die, which is disposed on a material sheet, for example, plastic sheet, is compressed by a press located thereabove, the press operation can be completed via a single process without requiring a separate process. This has the effect of preventing generation of poor products during the press operation and reducing labor and production costs. Accordingly, it can be said that the present invention is very advantages in the industry of die-board processing.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A pinnacle die structure having at least one scrap collecting opening, the pinnacle die structure comprising a pinnacle die which includes a supporting plate integrally formed with a cutter blade and at least one hole-processing pin,
wherein the hole-processing pin is internally formed with a scrap discharge hole to discharge a scrap of a material sheet.

2. The pinnacle die structure as set forth in claim 1, wherein the scrap collecting opening is defined above the hole-processing pin, which is internally formed with the scrap discharge hole to discharge the scrap of the material sheet, to collect the scrap discharged from the scrap discharge hole.

3. The pinnacle die structure as set forth in claim 2, wherein a synthetic resin film is provided to cover an open top side of the scrap collecting opening, in order to allow the scrap of the material sheet, which is discharged from the scrap discharge hole of the hole-processing pin, to be collected in the scrap collecting opening.

4. The pinnacle die structure as set forth in claim 2, wherein the scrap collecting opening has at least one pin support to support the edge of a pin blade of the hole-processing pin.

5. The pinnacle die structure as set forth in claim 2, wherein the at least one scrap collecting opening includes two or more scrap collecting openings integrally formed with each other.

6. The pinnacle die structure as set forth in claim 2, further comprising:
an iron board disposed on an upper surface of the pinnacle die including the supporting plate integrally formed with the cutter blade and hole-processing pin;
a wooden scrap collecting board disposed on an upper surface of the iron board and having a synthetic resin film attached at an upper surface thereof; and
a plurality of fixing pins penetrated through the synthetic resin film, wooden scrap collecting board, iron board, and pinnacle die to fixedly secure them together.

7. The pinnacle die structure as set forth in claim 2, wherein the hole-processing pin is welded to an upper surface of the pinnacle die.

8. The pinnacle die structure as set forth in claim 2, wherein the hole-processing pin takes the form of a block to be fitted into the pinnacle die.
